(19) United States
(12) Patent Application Publication
(10) Pub. No.: US 2025/0074354 A1
(43) Pub. Date: Mar. 6, 2025

(54) OPERATOR AUTHENTICATION SYSTEM AND METHOD FOR VEHICLE, VESSEL, OR HEAVY EQUIPMENT

(71) Applicant: Saudi Arabian Oil Company, Dhahran (SA)

(72) Inventors: Hussain Al-Rasheed, Dhahran (SA); Maryam Ahmed Bahmaid, Dhahran (SA)

(73) Assignee: Saudi Arabian Oil Company, Dhahran (SA)

(21) Appl. No.: 18/818,834

(22) Filed: Aug. 29, 2024

Related U.S. Application Data
(60) Provisional application No. 63/579,715, filed on Aug. 30, 2023.

(51) Int. Cl. G06F 21/32

(52) U.S. Cl. CPC B60R 25/01; B60R 25/102

(57) ABSTRACT

Operator authentication of a machine that requires an operator physically present at or in the machine to operate. The operator authentication may include occupancy detection, operator verification, and operator and machine status monitoring. The operator authentication may prevent any unauthorized person from operating the machine and help enforce training and license requirements for operation.

### CROSS-REFERENCE TO RELATED APPLICATIONS

This application claims priority from U.S. Provisional Application No. 63/579,715 filed Aug. 30, 2023, and titled “OPERATOR AUTHENTICATION SYSTEM AND METHOD FOR VEHICLE, VESSEL OR HEAVY EQUIPMENT.” For purposes of United States patent practice, this application incorporates the contents of the Provisional application by reference in its entirety.

### BACKGROUND

### Field of the Disclosure

The present disclosure generally relates to the operation of machines such as vehicles, vessels, and heavy equipment. More specifically, embodiments of the disclosure relate to authenticating the operators of such machines.

### Description of the Related Art

Various machines such as vehicles, vessels, and heavy equipment are used in a wide variety of industries. Most of these machines require an operator physically present to operate the machine. However, due to operational and regulatory requirements, the operators are typically required to have specific credentials, training, etc. to operate the machine. Additionally, during operation the machines and operators may be exposed to a number of suboptimal conditions that may prevent safe operation of the machine or increase the chance of mechanical failure.

### SUMMARY

Embodiments of the disclosure generally relate to the operator authentication of an operator-occupied machine. The operator authentication may include occupancy detection, operator verification (for example, license verification), and operator and machine status monitoring. The operator authentication may prevent any unauthorized person from operating the machine and help enforce training and license requirements for operation.

In some embodiments, an operator authentication system for a machine is provided. The system includes a plurality of occupancy detection devices configured to be installed in an operator compartment of the machine. The plurality of occupancy detection devices include a pressure sensor and a motion detector. The system includes one or more operator verification devices configured to be installed in the operator compartment of the machine. The one or more operator verification devices include a biometric capture device, a code reader, or a keypad. The system further includes a plurality of status devices configured to be installed in the machine. The plurality of status devices include a sound level meter, a GPS receiver, a hazardous gas sensor, a thermometer, a barometer, a fuel level sensor, and an external camera. The system also includes a computer-readable medium having executable code stored thereon. The executable code includes a set of instructions that causes a processor to perform operations that include receiving occupancy detection data from the plurality of occupancy detection devices, determining that the machine is occupied by an operator, receiving operator verification data from the one or more operator verification devices, and verifying that the operator is licensed to operate the machine. The instructions further include enabling operation of the machine by the operator, receiving, from the plurality of status devices, status data from the machine, and evaluating, using data, the status of the operator, the status of the machine, or a combination thereof.

In some embodiments, determining that the machine is occupied by an operator includes comparing data from the pressure sensor to a threshold. In some embodiments, verifying that the operator is licensed to operate the machine includes comparing the operator verification data to a database of verified data. In some embodiments, the operator verification data includes a personal identification number. In some embodiments, the operator verification data includes biometric data. In some embodiments, the operator verification data includes a quick response (QR) code, a machine readable zone (MRZ) code, a barcode, or any combination thereof. In some embodiments, the plurality of status devices includes a wind speed sensor, a fuel level sensor, a camera, a hazardous gas sensor, a sound level sensor, a thermometer, a barometer, or any combination thereof.

In another embodiment, a method of authenticating an operator of a machine is provided. The method includes receiving, from one or more first components of an operator authentication system, occupancy detection data, determining that the machine is occupied by an operator, receiving, from one or more second components of the operator authentication system, operator verification data, and verifying that the operator is licensed to operate the machine. The method also includes enabling, by the operator authentication system, operation of the machine by the operator, receiving, from one or more third components of the operator authentication system operator and machine status data from the machine, and evaluating, using the operator and machine status data, the status of the operator, the status of the machine, or a combination thereof.

In some embodiments, the occupancy detection data comprises infrared camera data, pressure sensor data, or a combination thereof. In some embodiments, determining that the machine is occupied by an operator comprises comparing the pressure sensor data to a threshold. In some embodiments, verifying that the operator is licensed to operate the machine comprises comparing the operator verification data to a database of verified data. In some embodiments, the operator verification data comprises a personal identification number. In some embodiments, the operator verification data comprises biometric data. In some embodiments, the operator verification data comprises a quick response (QR) code, a machine readable zone (MRZ) code, a barcode, or a combination thereof. In some embodiments, the status data comprises sound level data, hazardous gas sensor data, temperature data, humidity data, and video images. In some embodiments, the status data comprises a location of the machine, fuel level data, and wind speed data.

In another embodiment, a non-transitory computer-readable storage medium having executable code stored thereon for authenticating an operator of a machine. The executable code includes a set of instructions that causes a processor to perform operations that include receiving, from one or more first components of an operator authentication system, occupancy detection data, determining that the machine is occupied by an operator, receiving, from one or more second components of the operator authentication system, operator verification data, and verifying that the operator is licensed to operate the machine. The operations also include enabling, by the operator authentication system, operation of the machine by the operator, receiving, from one or more third components of the operator authentication system operator and machine status data from the machine, and evaluating, using the operator and machine status data, the status of the operator, the status of the machine, or a combination thereof.

In some embodiments, the occupancy detection data includes infrared camera data, pressure sensor data, or a combination thereof. In some embodiments, determining that the machine is occupied by an operator includes comparing the pressure sensor data to a threshold. In some embodiments, verifying that the operator is licensed to operate the machine includes comparing the operator verification data to a database of verified data. In some embodiments, the operator verification data includes a personal identification number. In some embodiments, the operator verification data includes biometric data. In some embodiments, the operator verification data includes a quick response (QR) code, a machine readable zone (MRZ) code, a barcode, or a combination thereof. In some embodiments, the status data includes sound level data, hazardous gas sensor data, temperature data, humidity data, and video images. In some embodiments, the status data includes a location of the machine, fuel level data, and wind speed data.

### BRIEF DESCRIPTION OF THE DRAWINGS

FIG. 1 is a schematic diagram of an operator-occupied machine and an operator authentication system in accordance with an embodiment of the disclosure;

FIG. 2 is a block diagram depicting the components of the operator-occupied machine and operator authentication system of FIG. 1 in accordance with an embodiment of the disclosure;

FIG. 3 is a block diagram of a process for operator authentication in accordance with an embodiment of the disclosure; and

FIG. 4 is a block diagram of an operator authentication processing system in accordance with an embodiment of the disclosure.

### DETAILED DESCRIPTION

The present disclosure will be described more fully with reference to the accompanying drawings, which illustrate embodiments of the disclosure. This disclosure may, however, be embodied in many different forms and should not be construed as limited to the illustrated embodiments. Rather, these embodiments are provided so that this disclosure will be thorough and complete, and will fully convey the scope of the disclosure to those skilled in the art.

Embodiments of the disclosure generally relate to the operator authentication and status monitoring of an operator-occupied machine. The operator authentication includes occupancy detection and operator verification (for example, license verification), and the status monitoring includes operator and machine status monitoring. The machine may be remotely enabled or disabled based on the operator authentication and status monitoring.

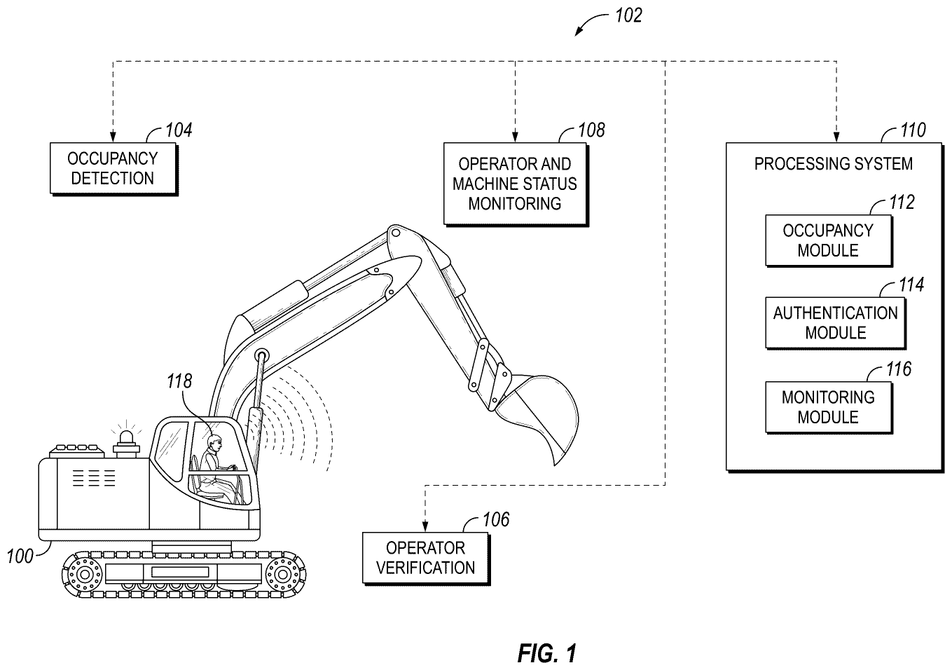

FIG. 1 is a schematic diagram of an operator-occupied machine 100 and an operator authentication system 102 in accordance with an embodiment of the disclosure. As used herein, the term “operator-occupied machine” refers to a machine that requires an operator physically present at or in the machine to operate. For example, an operator-occupied machine may include but is not limited to a vehicle, a vessel, a train, and heavy equipment (for example, tractors, excavators, and backhoes). Such machines may include machines powered by an internal combustion engine (ICE), electric motors, or hybrid vehicles. As used herein, the term “operator” is intended to include driver, pilot, captain, or other terms for person who operator an operator-occupied machine.

The operator authentication system 102 may include or be in communication with a processing system 104 that receives data from components of the operator authentication and status monitoring system 102 and may send a signal to the operator-occupied machine 100. For example, the operator-occupied machine 100 and the processing system 104 may communicate over a network (for example, the Internet or a local area network (LAN). In some embodiments, the processing system 104 may be implemented as a part of the machine 100, such that data from the components operator authentication system 102 send data to the processing system 104 over a local network or bus.

As shown in FIG. 1, the operator authentication and status monitoring system 102 may include occupancy detection 106, operator verification 108, and machine and operator status monitoring 110. Data from the occupancy detection 106, operator verification 108, machine and operator status monitoring 110, or any combination thereof may be transmitted to authentication processing system 112. The authentication processing system 112 may include an occupancy module 114, verification module 116, and machine and operator status module 118 which receive and process data from the corresponding components of the operator authentication system 102. As discussed in the disclosure, the occupancy module 114 may receive data from the occupancy detection 106 and determine whether the machine 100 is occupied by an operator (for example, operator 120). The verification module 116 may receive data from the operator verification 108 and verify that an operator is approved to operate the machine 100. The machine and operator status module 118 may receive data from the machine and operator status monitoring 110 to monitor environmental conditions and machine conditions and determine whether the operator, machine, or both are unsafe.

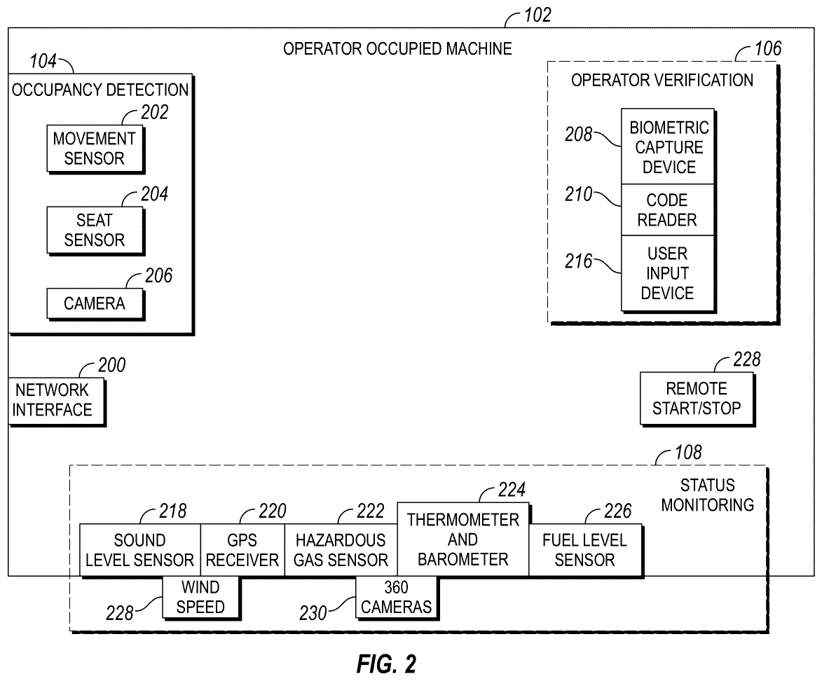

FIG. 2 depicts the components of the operator-occupied machine 100 and operator authentication system 102 in further detail in accordance with an embodiment of the disclosure. As shown in FIG. 2, the machine 100 may include a network interface 200 that provides for the transmission of data produced by components of the operator-occupied machine 100 and operator authentication system 102.

As shown in FIG. 2, the occupancy detection 160 may include one or more of the following: a motion detector 202, a seat sensor 204, and a video camera 206. The motion detector 202 may be an active or passive motion detector and may be installed in a cockpit of the machine 100 to detect movement of an operator in the cockpit. The motion detector 202 may use a passive infrared (PIR) sensor, a microwave sensor, or other suitable sensors or combinations thereof. The seat sensor 204 may be installed in a seat used by an operator of the machine 202. For example, the seat sensor 204 may be a pressure transducer installed in a seat such that the sensor may read the operators weight when the operator occupies the seat. The video camera 206 may be arranged to acquire photos, videos, or both of the cockpit or other area used by the operator. The images acquired by the camera 206 may be analyzed to determine whether the cockpit or other area is occupied by a human operator.

As shown in FIG. 2, the operator verification 106 may include one or more of the following: a biometric capture device 208, a code reader 210, and a user input device. The biometric capture device 208 may include one or more devices for capture biometrics from an operator. In some embodiments, these devices may be contact devices or contactless devices, and may include the following: a fingerprint scanner, a retina scanner, an iris scanner, a voice identification device, a facial recognition camera, or other suitable devices. The code reader 210 may read encoded information from a computer-generated code, a machine readable zone (MRZ), barcode (including PDF417 format used in RealID-compliant identification cards), or a magnetic stripe. The code reader 210 may thus include one or more of the following: a barcode reader, a quick-response (QR) code scanner, and a magnetic stripe reader. In some embodiments, the operator verification 106 may include a user input device 210, such as a keypad. In such embodiments, an operator may enter a passcode, personal identification number (PIN), or other entry using the user input device 210 to provide alternative or additional data for operator verification. In other embodiments, verification may be provided using an application executed on a smartphone or other personal computing device of an operator. In such embodiments, the operator may enter a passcode, personal identification number (PIN), or other entry in the application for verification, or the application may verify the operator using hardware, software, or both available on the personal computing device (such as a fingerprint reader). In some embodiments, after verification the application may provide a QR code readable by the code reader 210, which can then provide verification data.

The operator and machine status monitoring 108 may include one or more of the following: a sound level meter 218, a GPS receiver 220, a hazardous gas sensor 224, a thermometer and barometer 226, a fuel level sensor 226, and 360° cameras 228. The sound level meter 218 may be located in the cockpit of the machine 100 or any other suitable location. The sound level meter 218 may measure the sound in or around the machine 100 to ensure the noise is within safe levels for the operator. The GPS 220 may be used to determine the location of the machine 100 and may transmit the location to the processing system 110.

The hazardous gas sensor 224 may be located in the cockpit of the machine 100 or any other suitable area and may detect hazardous gases. In some embodiments, the hazardous gas sensor 224 may be a hydrogen sulfide (H₂S) sensor, such as a metal oxide semiconductor (MOS) sensor.

The thermometer and barometer 226 be located in the cockpit of the machine 100 or any other suitable area and may measure the temperature and humidity of the operating environment. For example, the temperature and humidity may be analyzed to determine heat stress danger for an operator of the machine 100.

The fuel level sensor 226 may measure the amount of fuel in one or more fuel tanks of the machine 100. For example, the fuel level sensor 226 may be include a float and variable resistor, such that the fuel level is measured by a correlation with the voltage measured across the variable resistor.

The wind speed sensor 228 (that is, an anemometer) may be located on the outside of the machine 100 and may measure the wind in the operating environment. For example, the wind speed sensor 228 may include one or more wind cups that rotate around a central axis and generate an output signal responsive to the rotation. The 360° cameras 230 may include cameras positioned on the exterior of the machine 100 and arranged to capture sufficient images to enable a stitched 360° view around the exterior of the machine 100.

In some embodiments, the machine 100 may also include an emergency button that automatically generates a notification to emergency personnel (for example, emergency medical services) when activated by an operator. The emergency button may be located in the cockpit of the machine 100 or in another location easily accessible by the operator.

The operator authentication system 102 may include or control a shutoff device 228 on the machine 100. For example, in response to the occupancy detection, operator verification, and health and status monitoring, the operator authentication system 102 may enable or disable operation of the machine 100 using the shutoff device 228. For example, the shutoff device 228 may be a hardware device (for example, an electronic switch) that is controlled by the authentication system 102. The hardware device may prevent operation of the machine 100 such as by preventing ignition of an internal combustion engine of the machine 100, preventing a key from turning an ignition switch, etc. In other embodiments, the shutoff device 228 may be implemented partially or fully in software to prevent operation of the machine 100.

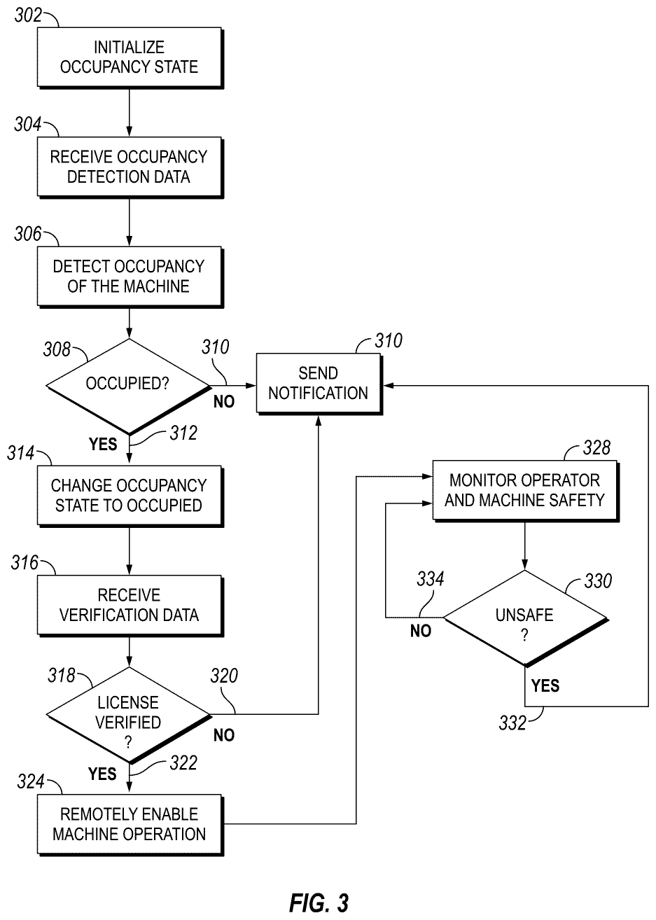

FIG. 3 depicts a process 300 for operator authentication in accordance with an embodiment of the disclosure. As shown in FIG. 3, the process 300 first initializes occupancy state and verification state of a machine (block 302), indicating that the machine is initialized as unoccupied. In some embodiments, initialization may include initialization the start/stop control to ensure that operation of the machine is disable.

Next, data from the occupancy detector is acquired (block 304) and occupancy of the machine is detected (blocks 306 and 308). If the machine is not occupied (line 308), operation of the machine is not enabled. In some embodiments, a notification may be sent to other personal associated with the machine, such as a site supervisor or project manager (block 310). If the machine is occupied (line 312), the occupancy state may be changed to “occupied” (block 314).

As shown in FIG. 3, data from the operator verification components may then be received (block 314) and the operator's license to operate the vehicle may be verified within a specified time period (block 316) to determine validity (decision block 318). If the license is not verified within the specified time period (line 320), operation of the machine is not enabled. In some embodiments, a notification may be sent to other personal associated with the machine, such as a site supervisor or project manager (block 310). If the license is verified (line 322), operation of the vehicle may be enabled via the start/stop sensor (block 324).

After operation of the machine is enabled, the operation and machine status data is acquired (block 326) and the operator and machine status may be monitored (blocks 328 and 330). If the operator, machine, or both are determined to be unsafe (line 332), a notification may be sent to other personnel, such as a site supervisor or project manager (block 310). If the operator, machine, or both are determined to be safe (line 334), the monitoring may continue until the machine is no longer in operation.

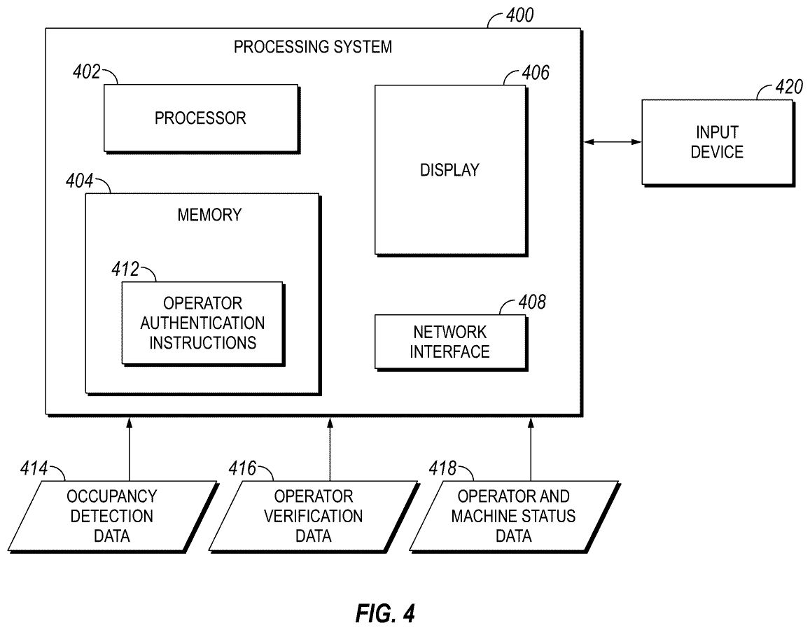

FIG. 4 depicts components of an operator authentication processing system 400 in accordance with an embodiment of the disclosure. The operator authentication processing system 400 may be in communication with other components, such as components of an operator-occupied machine as discussed herein. As shown in FIG. 4, the operator authentication processing system 400 may include a processor 402, a memory 404, a display 406, and a network interface 408. It should be appreciated that the operator authentication processing system 400 may include other components that are omitted for clarity. In some embodiments, operator authentication processing system 400 may include or be a part of a computer cluster, cloud-computing system, a data center, a server rack or other server enclosure, a server, a virtual server, a desktop computer, a laptop computer, a tablet computer, or the like.

The processor 402 (as used the disclosure, the term “processor” encompasses microprocessors) may include one or more processors having the capability to receive and process data, such as data an electronic drilling recorder (EDR). In some embodiments, the processor 402 may include an application-specific integrated circuit (AISC). In some embodiments, the processor 402 may include a reduced instruction set (RISC) processor or a complex instruction set (CISC) processor. Additionally, the processor 402 may include a single-core processors and multicore processors and may include graphics processors. Multiple processors may be employed to provide for parallel or sequential execution of one or more of the techniques described in the disclosure. The processor 402 may receive instructions and data from a memory (for example, memory 404).

The memory 404 (which may include one or more tangible non-transitory computer readable storage mediums) may include volatile memory, such as random access memory (RAM), and non-volatile memory, such as ROM, flash memory, a hard drive, any other suitable optical, magnetic, or solid-state storage medium, or a combination thereof. The memory 404 may be accessible by the processor 402. The memory 404 may store executable computer code. The executable computer code may include computer program instructions for implementing one or more techniques described in the disclosure. For example, the executable computer code may include operator authentication instructions 412 that define the various modules and processes to implement embodiments of the present disclosure. In some embodiments, the operator authentication instructions 412 may implement elements of process 300 described above and illustrated in FIG. 3. In some embodiments, the operator authentication instructions 412 may receive, as input, occupancy detection data 414, operator verification data 416, and operator and machine status data 418, as described in the disclosure. In some embodiments, the outputs from the operator authentication instructions 412 may be provided on the display 406.

The display 406 may include a cathode ray tube (CRT) display, liquid crystal display (LCD), an organic light emitting diode (OLED) display, or other suitable display. The display 406 may display a user interface (for example, a graphical user interface) that may display information received from the plant information processing computer 406. In accordance with some embodiments, the display 406 may be a touch screen and may include or be provided with touch sensitive elements through which a user may interact with the user interface.

The network interface 408 may provide for communication between the operator authentication processing system 400 and other devices. The network interface 408 may include a wired network interface card (NIC), a wireless (for example, radio frequency) network interface card, or combination thereof. The network interface 408 may include circuitry for receiving and sending signals to and from communications networks, such as an antenna system, an RF transceiver, an amplifier, a tuner, an oscillator, a digital signal processor, and so forth. The network interface 408 may communicate with networks, such as the Internet, an intranet, a wide area network (WAN), a local area network (LAN), a metropolitan area network (MAN) or other networks. Communication over networks may use suitable standards, protocols, and technologies, such as Ethernet Bluetooth, Wireless Fidelity (Wi-Fi) (for example, IEEE 802.11 standards), and other standards, protocols, and technologies.

In some embodiments, the operator authentication processing system 400 may be coupled to an input device 420 (for example, one or more input devices). The input device 420 may include, for example, a keyboard, a mouse, a microphone, or other input devices. In some embodiments, the input device 420 may enable interaction with a user interface displayed on the display 406. For example, in some embodiments, the input devices 420 may enable the entry of inputs that control the acquisition of data from an operator-occupied machine, the selection of notifications, etc.

Ranges may be expressed in the disclosure as from about one particular value, to about another particular value, or both. When such a range is expressed, it is to be understood that another embodiment is from the one particular value, to the other particular value, or both, along with all combinations within said range.

Further modifications and alternative embodiments of various aspects of the disclosure will be apparent to those skilled in the art in view of this description. Accordingly, this description is to be construed as illustrative only and is for the purpose of teaching those skilled in the art the general manner of carrying out the embodiments described in the disclosure. It is to be understood that the forms shown and described in the disclosure are to be taken as examples of embodiments. Elements and materials may be substituted for those illustrated and described in the disclosure, parts and processes may be reversed or omitted, and certain features may be utilized independently, all as would be apparent to one skilled in the art after having the benefit of this description. Changes may be made in the elements described in the disclosure without departing from the spirit and scope of the disclosure as described in the following claims. Headings used in the disclosure are for organizational purposes only and are not meant to be used to limit the scope of the description.

What is claimed is:

1. An operator authentication system for a machine, comprising:
a plurality of occupancy detection devices configured to be installed in an operator compartment of the machine, the plurality of occupancy detection devices comprising a pressure sensor and a motion detector;
one or more operator verification devices configured to be installed in the operator compartment of the machine, the one or more operator verification devices comprising a biometric capture device, a code reader, or a keypad; and
a plurality of status devices configured to be installed in the machine, the plurality of status devices comprising a sound level meter, a GPS receiver, a hazardous gas sensor, a thermometer, a barometer, a fuel level sensor, and an external camera;
a computer-readable medium having executable code stored thereon, the executable code comprising a set of instructions that causes a processor to perform operations comprising:
receiving occupancy detection data from the plurality of occupancy detection devices;
determining that the machine is occupied by an operator;
receiving operator verification data from the one or more operator verification devices;
verifying that the operator is licensed to operate the machine;
enabling operation of the machine by the operator;
receiving, from the plurality of status devices, status data from the machine; and
evaluating, using data, the status of the operator, the status of the machine, or a combination thereof.

2. The system of claim 2, wherein determining that the machine is occupied by an operator comprises comparing data from the pressure sensor to a threshold.

3. The system of claim 1, wherein verifying that the operator is licensed to operate the machine comprises comparing the operator verification data to a database of verified data.

4. The system of claim 1, wherein the operator verification data comprises a personal identification number.

5. The system of claim 1, wherein the operator verification data comprises biometric data.

6. The system of claim 1, wherein the operator verification data comprises a quick response (QR) code, a machine readable zone code, a barcode, or any combination thereof.

7. The system of claim 1, wherein the plurality of status devices comprises a wind speed sensor, a fuel level sensor, a camera, a hazardous gas sensor, a sound level sensor, a thermometer, a barometer, or any combination thereof.

8. A method of authenticating an operator of a machine, comprising:
receiving, from one or more first components of an operator authentication system, occupancy detection data;
determining that the machine is occupied by an operator;
receiving, from one or more second components of the operator authentication system, operator verification data;
verifying that the operator is licensed to operate the machine;
enabling, by the operator authentication system, operation of the machine by the operator;
receiving, from one or more third components of the operator authentication system operator and machine status data from the machine; and
evaluating, using the operator and machine status data, the status of the operator, the status of the machine, or a combination thereof.

9. The method of claim 8, wherein the occupancy detection data comprises infrared camera data, pressure sensor data, or a combination thereof.

10. The method of claim 9, wherein determining that the machine is occupied by an operator comprises comparing the pressure sensor data to a threshold.

11. The method of claim 8, wherein verifying that the operator is licensed to operate the machine comprises comparing the operator verification data to a database of verified data.

12. The method of claim 8, wherein the operator verification data comprises a personal identification number.

13. The method of claim 8, wherein the operator verification data comprises biometric data.

14. The method of claim 8, wherein the operator verification data comprises a quick response (QR) code, a machine readable zone code, a barcode, or a combination thereof.

15. The method of claim 8, wherein the status data comprises sound level data, hazardous gas sensor data, temperature data, humidity data, and video images.

16. The method of claim 8, wherein the status data comprises a location of the machine, fuel level data, and wind speed data.

17. A non-transitory computer-readable storage medium having executable code stored thereon for authenticating an operator of a machine, the executable code comprising a set of instructions that causes a processor to perform operations comprising:
receiving, from one or more first components of an operator authentication system, occupancy detection data;
determining that the machine is occupied by an operator;
receiving, from one or more second components of the operator authentication system, operator verification data;
verifying that the operator is licensed to operate the machine;
enabling, by the operator authentication system, operation of the machine by the operator;
receiving, from one or more third components of the operator authentication system operator and machine status data from the machine; and
evaluating, using the operator and machine status data, the status of the operator, the status of the machine, or a combination thereof.

18. The non-transitory computer-readable storage medium of claim 17, wherein the occupancy detection data comprises infrared camera data, pressure sensor data, or a combination thereof.

19. The non-transitory computer-readable storage medium of claim 18, wherein determining that the machine is occupied by an operator comprises comparing the pressure sensor data to a threshold.

20. The non-transitory computer-readable storage medium of claim 17, wherein verifying that the operator is licensed to operate the machine comprises comparing the operator verification data to a database of verified data.

21. The non-transitory computer-readable storage medium of claim 17, wherein the operator verification data comprises a personal identification number.

22. The non-transitory computer-readable storage medium of claim 17, wherein the operator verification data comprises biometric data.

23. The non-transitory computer-readable storage medium of claim 17, wherein the operator verification data comprises a quick response (QR) code, a machine readable zone code, a barcode, or a combination thereof.

24. The non-transitory computer-readable storage medium of claim 17, wherein the status data comprises sound level data, hazardous gas sensor data, temperature data, humidity data, and video images.

25. The non-transitory computer-readable storage medium of claim 17, wherein the status data comprises a location of the machine, fuel level data, and wind speed data.
